(19) United States
(12) Patent Application Publication
(10) Pub. No.: US 2003/0117672 A1
(43) Pub. Date: Jun. 26, 2003

(54) Dynamic CCD line length timing for color scanners

(75) Inventor: Gordon Geisbuesch, Fairport, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/027,745

(22) Filed: Dec. 20, 2001

(51) Int. Cl. H04N 1/04

(52) U.S. Cl. 358/485

(57) ABSTRACT

A line clocking arrangement is used in a scanner for synchronizing the line readout of a clocked imaging device with the motion of an object being scanned. The line clocking arrangement includes an encoder for sensing movement of the object being scanned and generating a sync signal in correspondence with a movement of the object, and a timing generation circuit for generating clock signals for controlling the clocked imaging device. The clock signals include a drain clock signal for controlling the dumping of charge into an overflow drain and an output clock signal for clocking image charge through an horizontal output register. The timing generation circuit receives the sync signal and times the duration of the drain clock signal and the beginning of the output clock signal to the occurrence of the sync signal, whereby the line readout time is dynamically adjusted to changes in velocity of the scanned object during a period when charge is being dumped into the overflow drain.

### FIELD OF THE INVENTION

This invention relates generally to the operation of linear charge coupled device (CCD) imagers and, more particularly, to synchronizing the CCD readout with the motion of the object being scanned.

### BACKGROUND OF THE INVENTION

When operating a linear film scanner it is important that the film being scanned has constant velocity. In addition, if a CCD imager with electronic exposure control is used, the exposure for every line should be the same. (This technique is shown in commonly assigned U.S. Pat. No. 5,105,264, entitled “Color image sensor having an optimum exposure time for each color” and issued Apr. 14, 1992 in the name of H. Erhardt.)

In a color film scanner with a tri-linear CCD sensor (i.e., a CCD having three color sensors respectively sensitive to three colors, e.g., red, green and blue), any speed variation in the transport of the film can result in color fringing effects in the resulting image. This effect will be noticed in the slow scan direction and can result in unacceptable image artifacts.

In U.S. Pat. No. 4,205,337, the time interval between successive scans is varied in order to switch between film formats including television standards of fifty or sixty frames per second, and motion picture film rates of twenty-four and twenty-five frames per second. A variable frequency oscillator is used to set up a chosen operating speed for a given frame rate. While such techniques as disclosed in this patent can effectively handle varying frame rates, what is needed is a technique for line by line compensation of the time interval between successive scans within a frame, and in particular a technique for doing this without creating dark signal artifacts between line captures because of line variability.

### SUMMARY OF THE INVENTION

The present invention is directed to overcoming one or more of the problems set forth above. Briefly summarized, according to one aspect of the present invention, the invention overcomes the limitations of conventional systems by utilizing a line clocking arrangement in a scanner for synchronizing the line readout of a clocked imaging device with the motion of an object being scanned. The imaging device includes a photosensitive area, an overflow drain, a horizontal output register, a drain gate interposed between the photosensitive area and the overflow drain, and one or more transfer gates interposed between the photosensitive area and the horizontal output register for transferring charge between the photosensitive area and the horizontal output register. The line clocking arrangement includes an encoder for sensing movement of the object being scanned and generating a sync signal in correspondence with a movement of the object, and a timing generation circuit for generating clock signals for controlling the clocked imaging device. The clock signals include a drain clock signal for controlling the dumping of charge into the overflow drain and an output clock signal for clocking image charge through the horizontal output register. The timing generation circuit receives the sync signal and times the duration of the drain clock signal and the beginning of the output clock signal to the occurrence of the sync signal, whereby the line readout time is dynamically adjusted to changes in velocity of the scanned object during a period when charge is being dumped into the overflow drain.

By using an encoder to monitor the position of the film in the gate, the resulting information can be used to slightly lengthen or shorten the CCD line readout time, thereby synchronizing the line readout to the motion of the scanned object. Of particular advantage, the change in line readout time occurs when the CCD is not integrating electrons but is dumping electrons into the overflow drain. Application of this technique thereby minimizes dark signal differences between line captures.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a diagram of a single channel of a linear CCD imager known in the prior art.

FIG. 2 shows a set of waveform diagrams for the line clocking of the linear CCD imager shown in FIG. 1.

FIG. 3 shows the waveform diagrams of FIG. 2 modified in accordance with the invention to dynamically control the line length of the linear CCD imager shown in FIG. 1.

FIG. 4 is a waveform diagram expanding the beginning of the first line shown in FIG. 3.

FIG. 5 is a waveform diagram expanding the beginning of the second line shown in FIG. 3.

FIG. 6 is a diagram of a single channel of another type of linear CCD imager known in the prior art.

FIG. 7 shows waveform diagrams modified in accordance with the invention to dynamically control the line length of the linear CCD imager shown in FIG. 6.

FIG. 8 is a waveform diagram expanding the beginning of the first line shown in FIG. 7.

FIG. 9 is a waveform diagram expanding the beginning of the second line shown in FIG. 7.

FIG. 10 is a block diagram of a color scanner utilizing dynamic control of the line length of its linear CCD imager in accordance with the invention.

### DETAILED DESCRIPTION OF THE INVENTION

Because CCD imaging devices and line clocking techniques for use therewith are well known, the present description will be directed in particular to elements forming part of, or cooperating more directly with, apparatus in accordance with the present invention. Elements not specifically shown or described herein may be selected from those known in the art.

Referring first to FIG. 10, a color scanner is shown to include a light source 1, a circle to line converter 2 for generating a scanning line 2a on an object 3 that is to be scanned, and a lens 4 for imaging the scanning line 2a on a tri-linear CCD imager 5. The tri-linear CCD imager 5 includes separate CCD arrays 5a, 5b and 5c responsive to red, green and blue light, respectively. In the preferred embodiment, the object to be scanned is a transparent color film, such as a photographic negative or positive (slide) film, that is moved in a direction 3a by a conventional film drive mechanism 3b. However, this embodiment is understood to be without limitation, and the scanned object could be something else, such as a print or copy material, and the collection optics could be adapted for a reflective system, instead of the transmissive system as shown in FIG. 10. The output signals from the tri-linear CCD imager 5 are digitized in an A/D converter 6 and applied to a digital signal processor 7 for subsequent processing, which is not part of this invention. A synchronizing signal (Sync) is generated by an encoder 8 that indicates the position of the film 3 as it passes through the scanner. The Sync signal is applied to a CCD and datapath timing generation circuit 9, which provides the circuit elements for generating line clocking signals that dynamically control the line length of the linear CCD imager in accordance with the invention.

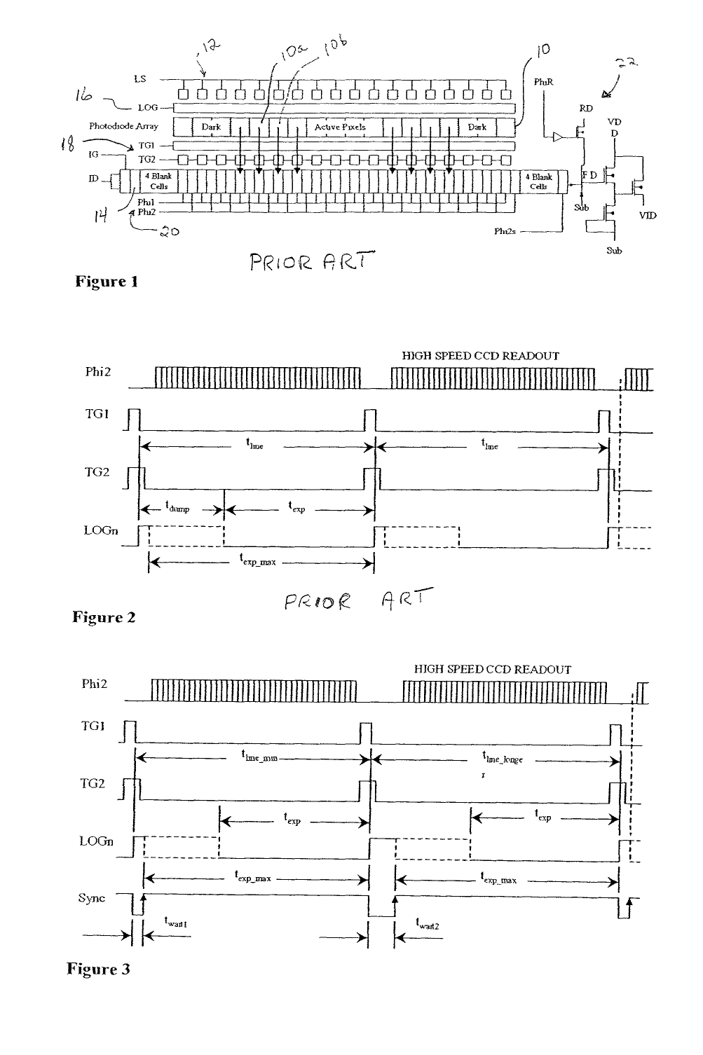

FIG. 1 shows a single channel of a linear CCD imager used in the tri-linear CCD imager 5 shown in FIG. 1. The imager includes a photodiode array 10 (composed of individual photodiodes 10a, 10b . . . ), a drain structure (LS drain) 12 and a horizontal shift register 14. A gate (LOGn gates) 16 is interposed between the photodiode array 10 and the drain structure 12, and transfer gates (TG1 and TG2) 18 are interposed between the photodiode array 10 and the horizontal shift register 14. Horizontal register clocks (PH1 and PH2) 20 are provided to clock the image signal out of the horizontal shift register 14. Output circuitry 22 provides conventional treatment of the output image signal, such as correlated double sampling to provide analog output samples to the A/D converter 6.

Exposure control is implemented by selectively clocking the LOGn gates 16 during portions of the scanning line time. First, the charge collected in the photodiode array 10 is drawn off to the LS drain 12 by positively biasing the LOGn gates 16 while TG1 is in an off state. By changing the LOGn biasing to the opposite state during the line, the charge generated in the photodiodes 10a, 10b . . . is no longer dumped into the LS drain 12 but instead accumulated in the photodiode array 10. At the end of the exposure period the collected charge is moved into the horizontal shift register 14 using the TG clocks 18 and then read out of the CCD using the Phi clocks 20.

FIG. 2 shows the normal clocking operation of the linear imager shown in FIG. 1. The line period is denoted by tₗᵢₙₑ in the figure, with LOGn starting the line switching high and TG1 starting the line switching low. With TG1 low and LOGn high the charge collected in the photodiode will be drawn off to the LS drain. At some time later (t_{dump}) the LOGn clock is switched low and the charge is collected in the photodiode. The effective exposure time (tₑₓₚ) is the net time between the falling edge of the LOGn clock and the falling edge of the TG1 clock.

FIG. 3 shows the clocking for dynamically controlling the line length of the of the CCD imager according to the invention. The signal Sync is received by the CCD and datapath timing generation circuit 9 from the encoder 8 that indicates the position of the item to be scanned. Since the velocity of the item to be scanned may have moved faster or slower than nominally expected, the timing generation logic will use this Sync signal to compensate for the variation in velocity. In this example, for the first line capture the item to be scanned has moved quickly, so the Sync signal has a positive edge transition soon after the TG1 falling edge (t_{wait1}) but after the TG2 falling edge. The Sync rising edge is used to reset the internal counters in the timing generation logic used for clocking the next line of pixels, and will stay high until the TG1 signal switches low at the end of line (tₑₓₚ_{_{—}}ₘₐₓ). The first line shown in FIG. 3 therefor has a minimum line length for this first line acquired (tₗᵢₙₑ_{_{—}}ₘᵢₙ). The item being scanned has not moved as quickly for the second line scanned and therefor the length of the second line is longer (tₗᵢₙₑ_{_{—}}_{longer}). Notice that the Sync rising edge has been delayed from the falling edge of TG1 (t_{wait2} is greater than t_{wait1}) for the second line. In order to compensate for this increase in line length the time between the falling edge of TG2 and the start of the Phi2 clock has been increased as shown in FIG. 3. For clarity it should be noted that for both lines in this figure the duration of the TG1 and TG2 pulses are always the same. In particular is important to hold TG2 low when waiting for the Sync signal rising edge so as to minimize the generation of dark signal in the TG2 gate area. Also note that tₑₓₚ and tₑₓₚ_{_{—}}ₘₐₓ are the same for both lines shown, while the tₗᵢₙₑ_{_{—}}ₘᵢₙ has a shorter duration than tₗᵢₙₑ_{_{—}}_{longer}. The advantage of clocking in this way is that the dark signal generated during the time when TG2 switches low and the start of electronic exposure when LOGn goes low will be dumped into the LS drain 12 of the CCD imager. The result is that both lines captured will have the same integrated dark signal from the photodiode, which is the major contributor to dark signal in the CCD.

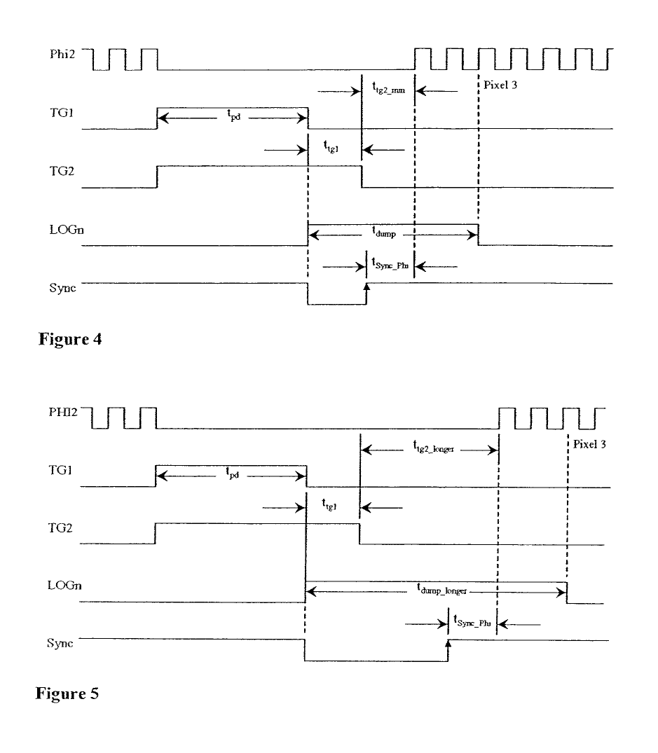

FIG. 4 expands the beginning of the first line shown in FIG. 3 while FIG. 5 expands the beginning of the second line shown in FIG. 3. In these figures the TG1 (t_{pd}) and the TG2 (t_{pd}+t_{tg1}) pulsewidths are the same. The section of the line that varies is the time between the falling edge of TG2 and the start of the Phi2 clock (t_{tg2}_{_{—}}ₘᵢₙ versus t_{tg2}_{_{—}}_{longer}). As a result, the amount of time spent dumping charge into the LS drain 12 is extended from t_{dump} to t_{dump}_{_{—}}_{longer}. In both FIG. 4 and FIG. 5, the time between the rising edge of Sync and the start of the Phi2 clock is constant (t_{sync}_{_{—}}ₚₕᵢ). Note that in this example the LOGn signal goes low and charge is acquired in both FIG. 4 and FIG. 5 at pixel 3 of the line, resulting in the same tₑₓₚ time in both cases.

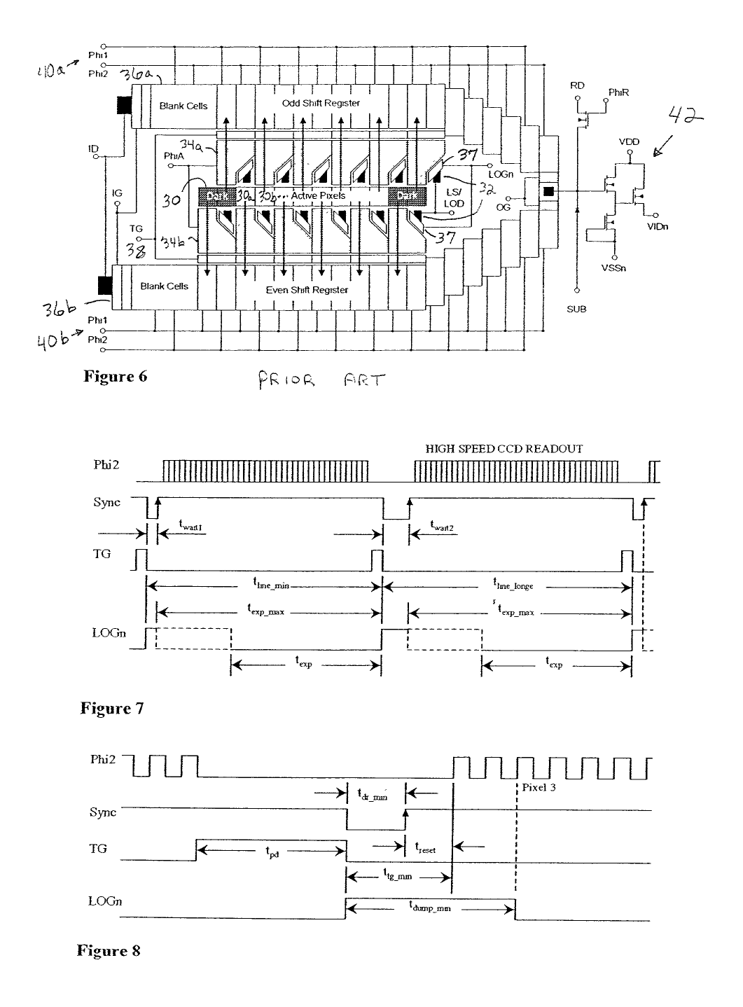

FIG. 6 shows a single channel of a second known example of a linear CCD imager that has a single TG gate with an adjacent accumulation region. The imager includes a photodiode array 30 (composed of individual photodiodes 30a, 30b . . . ), a overflow drain structure (LS drain) 32, a pair of accumulation regions 34a and 34b and a pair (odd and even) of horizontal shift registers 36a and 36b. A gate structure (LOGn gates) 37 is interposed between the accumulation regions 34a and 34b and the drain structure 32, and a single transfer gate connection (TG) 38 is interposed between the accumulation regions 34a and 34b and the horizontal shift registers 36a and 36b. Respective horizontal register clocks (PH1 and PH2) 40a and 40b are provided to clock the image signal out of the horizontal shift registers 36a and 36b. Output circuitry 42 provides conventional treatment of the output image signal, such as correlated double sampling to provide analog output samples to the A/D converter 6. In operation, the charge moves immediately out of the photodiodes 30a, 30b . . . and into the accumulation regions 34a and 34b, where it can be dumped to the overflow drain structure 32 or transferred to the horizontal registers 36a and 36b, depending on the state of the gate structure 37 and the transfer gate connection 38. The LS and PhiA gates are set with a DC bias while the TG and LOGn gates are clocked for vertical transfer.

FIG. 7 shows the line clocking of a CCD imager that is shown in FIG. 6. As before, the signal Sync is received by the CCD and datapath timing generation circuit 9 from the encoder 8 that indicates the position of the item to be scanned. Since the velocity of the item to be scanned may have moved faster or slower than nominally expected, the timing generation logic will use this Sync signal to compensate for the variation in velocity. The first line in this figure has a minimum line time (tₗᵢₙₑ_{_{—}}ₘᵢₙ). while the second line has a longer line time (tₗᵢₙₑ_{_{—}}_{longer}). Notice that the total electronic exposure time is the same for both lines (tₑₓₚ).

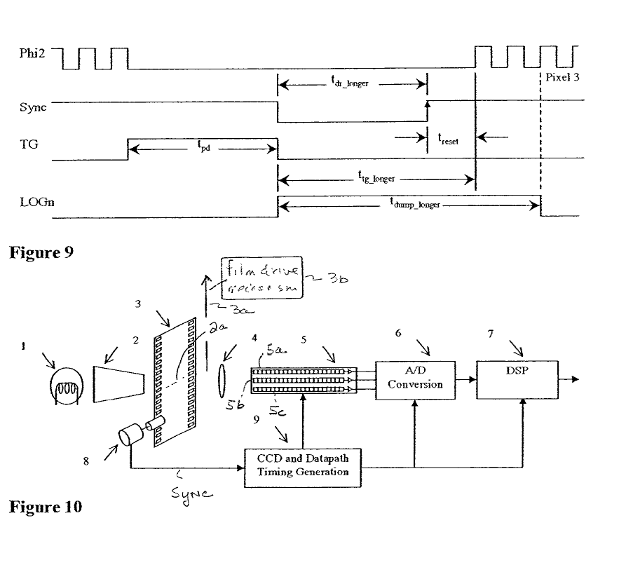

FIG. 8 expands the beginning of the first line shown in FIG. 7 while FIG. 9 expands the beginning of the second line shown in FIG. 7. Once again it is critical that the extra line time be located between the TG falling edge and the start of the Phi2 clock. In these figures the TG (t_{pd}) pulsewidth is the same for both the minimum and longer lines. Notice that the LOGn has a minimum dump duration of t_{dump}_{_{—}}ₘᵢₙ, so the Sync pulsewidth must have at least a t_{dr}_{_{—}}ₘᵢₙ minimum time in the low state. The advantage of clocking in this way is once again that the dark signal generated in the photodiode during the time when TG switches low and the start of electronic exposure when LOGn switches low will be dumped into the LS drain 37 of the CCD imager.

The invention has been described in detail with particular reference to certain preferred embodiments thereof, but it will be understood that variations and modifications can be effected within the spirit and scope of the invention.

### PARTS LIST

1 light Source

2 circle to line converter

2a scanning line

3 film

3a direction of film motion

3b film drive mechanism

4 lens

5 tri-linear CCD sensor

5a red CCD

5b green CCD

5c blue CCD

6 A/D converter(s)

7 digital Signal Processing

8 encoder

9 CCD and datapath timing generation

10 photodiode array

10a,b individual photosite

12 drain structure

14 horizontal shift register

16 gate

18 transfer gates

20 horizontal register clocks

22 output circuitry

30 photodiode array

32 overflow drain structure

34a accumulation region

34b accumulation region

36a odd horizontal shift register

36b even horizontal shift register

37 gate structure

38 transfer gate connection

40a horizontal register clock

40b horizontal register clock

42 output circuitry

What is claimed is:

1. A line clocking arrangement used in a scanner for synchronizing the line readout of a clocked imaging device with the motion of an object being scanned; said imaging device including a photosensitive area, an overflow drain, at least one horizontal output register, a drain gate interposed between the photosensitive area and the overflow drain, and one or more transfer gates interposed between the photosensitive area and the horizontal output register for transferring charge between the photosensitive area and the horizontal output register; said arrangement comprising:
an encoder for sensing movement of the object being scanned and generating a sync signal in correspondence with a movement of the object; and
a timing generation circuit for generating clock signals for controlling the clocked imaging device, said clock signals including a drain clock signal for controlling the dumping of charge into the overflow drain and an output clock signal for clocking image charge through the horizontal output register, wherein the timing generation circuit receives the sync signal and times the duration of the drain clock signal and the beginning of the output clock signal to the occurrence of the sync signal, whereby the line readout time is dynamically adjusted to changes in velocity of the scanned object during a period when charge is being dumped into the overflow drain.

2. The arrangement as claimed in claim 1 wherein the beginning of the output clock signal is delayed to accommodate a slower velocity in the movement of the scanned object.

3. The arrangement as claimed in claim 1 wherein the duration of the drain clock signal is extended to accommodate a slower velocity in the movement of the scanned object.

4. The arrangement as claimed in claim 1 wherein the object to be scanned is a photographic film.

5. The arrangement as claimed in claim 1 wherein the clocked imaging device is a tri-linear CCD imaging device.

6. A line clocking arrangement used in a scanner for synchronizing the line readout of a clocked imaging device with the motion of an object being scanned; said imaging device including a photosensitive area, an overflow drain, at least one horizontal output register, an accumulation region arranged adjacent the photosensitive area to accumulate charge before transfer to either the overflow drain or the output register, a drain gate interposed between the accumulation region and the overflow drain, and one or more transfer gates interposed between the accumulation region and the horizontal output register for transferring charge between the accumulation region and the horizontal output register; said arrangement comprising:
an encoder for sensing movement of the object being scanned and generating a sync signal in correspondence with a movement of the object; and
a timing generation circuit for generating clock signals for controlling the clocked imaging device, said clock signals including a drain clock signal for controlling the dumping of charge from the accumulation region into the overflow drain and an output clock signal for clocking image charge through the horizontal output register, wherein the timing generation circuit receives the sync signal and times the duration of the drain clock signal and the beginning of the output clock signal to the occurrence of the sync signal, whereby the line readout time is dynamically adjusted to changes in velocity of the scanned object during a period when charge is being dumped into the overflow drain.

7. The arrangement as claimed in claim 6 wherein the beginning of the output clock signal is delayed to accommodate a slower velocity in the movement of the scanned object.

8. The arrangement as claimed in claim 6 wherein the duration of the drain clock signal is extended to accommodate a slower velocity in the movement of the scanned object.

9. The arrangement as claimed in claim 6 wherein the object to be scanned is a photographic film.

10. The arrangement as claimed in claim 6 wherein the clocked imaging device is a tri-linear CCD imaging device.

11. A method for synchronizing the line readout of a clocked imaging device with the motion of an object being scanned; said imaging device including a photosensitive area, an overflow drain, a horizontal output register, and a drain gate; said method comprising the steps of:
sensing movement of the object being scanned and generating a sync signal in correspondence with a movement of the object; and
generating a drain clock signal for controlling the dumping of charge into the overflow drain;
generating an output clock signal for clocking image charge through the horizontal output register; and
timing the duration of the drain clock signal and the beginning of the output clock signal to the occurrence of the sync signal, whereby the line readout time is dynamically adjusted to changes in velocity of the scanned object during a period when charge is being dumped into the overflow drain.

12. The method as claimed in claim 11 wherein the beginning of the output clock signal is delayed to accommodate a slower velocity in the movement of the scanned object.

13. The method as claimed in claim 11 wherein the duration of the drain clock signal is extended to accommodate a slower velocity in the movement of the scanned object.
